(19) United States
(12) Patent Application Publication
(10) Pub. No.: US 2015/0296237 A1
(43) Pub. Date: Oct. 15, 2015

(54) ELECTRONIC DEVICE AND METHOD FOR CONTROLLING THE SAME

(71) Applicants: KABUSHIKI KAISHA TOSHIBA, Tokyo (JP); TOSHIBA LIFESTYLE PRODUCTS & SERVICES CORPORATION, Tokyo (JP)

(72) Inventor: Fujihito Numano, Tokyo (JP)

(21) Appl. No.: 14/556,649

(22) Filed: Dec. 1, 2014

Related U.S. Application Data
(60) Provisional application No. 61/979,206, filed on Apr. 14, 2014.

(51) Int. Cl. H04N 21/2543; H04L 29/06; H04N 21/478; H04N 7/16; H04N 5/445; H04N 21/431; G06Q 20/14; H04N 7/173

(52) U.S. Cl. CPC H04N 21/2543; G06Q 20/145; H04L 65/4084; H04N 7/17309; H04N 7/162; H04N 5/445; H04N 21/4312; H04N 21/4781

(57) ABSTRACT

According to one embodiment, a broadcast receiver including, a display configured to display an image of reproduced content, and a controller configured to, when a support device configured to support character input is not connected and the content displayed by the display is paid content, transmit settlement information related to settlement of fees to a communication device holding contract information of the paid content or a specific management device.

### CROSS-REFERENCE TO RELATED APPLICATIONS

This application claims the benefit of U.S. Provisional Application No. 61/979,206, filed Apr. 14, 2014, the entire contents of which are incorporated herein by reference.

### FIELD

Embodiments described herein relate generally to an electronic device and a method for controlling the same.

### BACKGROUND

Recently, many televisions (broadcast receivers) which receive and reproduce television broadcasts (programs) or which are connected to a cable television network to obtain and reproduce content (programs/games) have also had a function for being connected to a communication network.

In many cases, content offered by communication networks is charged. Paid content includes content which is available by paying fees (making settlement) for every use (connection) or by paying fees (making settlement) depending on the available period. For example, such content includes games (applications).

However, input of payment information for paying fees (making settlement) for paid content is very troublesome in televisions which do not have a dedicated input mechanism such as a keyboard.

In the case where the payment (settlement) for charged content is realized by a prepaid method using a personal computer or mobile device, etc., content which is available by making settlement (paying fees) such as games is disadvantageous in terms of immediacy since users can enjoy the games only after the settlement is completed. In the case where a game can be used for free for a certain period (time) but requires settlement (payment for fees) for continuous use, there is a need for the user to be able to make settlement via the television (in use) without trouble while the user enjoys the game.

For example, when a game is selected, the operation mode of the television is preferably automatically switched to an operation mode suitable for games.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of an image reproduction device (paid content settlement system) according to an embodiment;

FIG. 2 is an exemplary diagram showing an example of an image reproduction device according to an embodiment;

FIG. 3 is an exemplary diagram showing an example of an external device configured to construct a settlement system according to an embodiment;

FIG. 4 is an exemplary diagram showing an example of a method for specifying a settlement system according to an embodiment;

FIG. 5 is an exemplary diagram showing an example of a display during operation of an image reproduction device according to an embodiment;

FIG. 6 is an exemplary diagram showing an example of a method for selecting activation of paid content from an image reproduction device in operation according to an embodiment;

FIG. 7 is an exemplary diagram showing an example of a settlement screen display at the time of activating paid content requiring payment of fees according to an embodiment;

FIG. 8 is an exemplary diagram showing an example of a method for specifying a way of paying fees (settlement/purchase) for paid content according to an embodiment;

FIG. 9 is an exemplary diagram showing an example of a method for specifying a way of paying fees (settlement/purchase) for paid content according to an embodiment;

FIG. 10 is an exemplary diagram showing an example of a screen for paying fees for paid content (settlement company) according to an embodiment;

FIG. 11 is an exemplary diagram showing an example of a screen in which content reproduction is allowed to be started after payment (settlement) of fees according to an embodiment;

FIG. 12 is an exemplary diagram showing an example of a guidance display screen configured to indicate purchased unit completion after payment (settlement) of fees according to an embodiment;

FIG. 13A is an exemplary diagram showing an example of a change in the operation mode of an image reproduction device when payment of fees for paid content is completed according to an embodiment;

FIG. 13B is an exemplary diagram showing an example of a change in the operation mode according to an embodiment following the change in the operation mode shown in FIG. 13A;

FIG. 14 is an exemplary diagram showing an example of an input screen configured to confirm the difference in the operation mode according to an embodiment;

FIG. 15 is an exemplary diagram showing an example of a display showing the difference in the operation mode according to an embodiment;

FIG. 16 is an exemplary diagram showing an example of a screen display during reproduction of paid content according to an embodiment;

FIG. 17 is an exemplary diagram showing an example of a feedback screen display to the supplier of paid content according to an embodiment;

FIG. 18 is an exemplary diagram showing an example of a method for specifying a way of paying fees (settlement/purchase) for paid content according to an embodiment; and

FIG. 19 is an exemplary diagram showing an example of a screen for paying fees for paid content (settlement company) according to an embodiment.

### DETAILED DESCRIPTION

Various embodiments will be described hereinafter with reference to the accompanying drawings.

In general, according to one embodiment, a broadcast receiver comprising, a display configured to display an image of reproduced content, and a controller configured to, when a support device configured to support character input is not connected and the content displayed by the display is paid content, transmit settlement information related to settlement of fees to a communication device holding contract information of the paid content or a specific management device.

Embodiments will now be described hereinafter in detail with reference to the accompanying drawings.

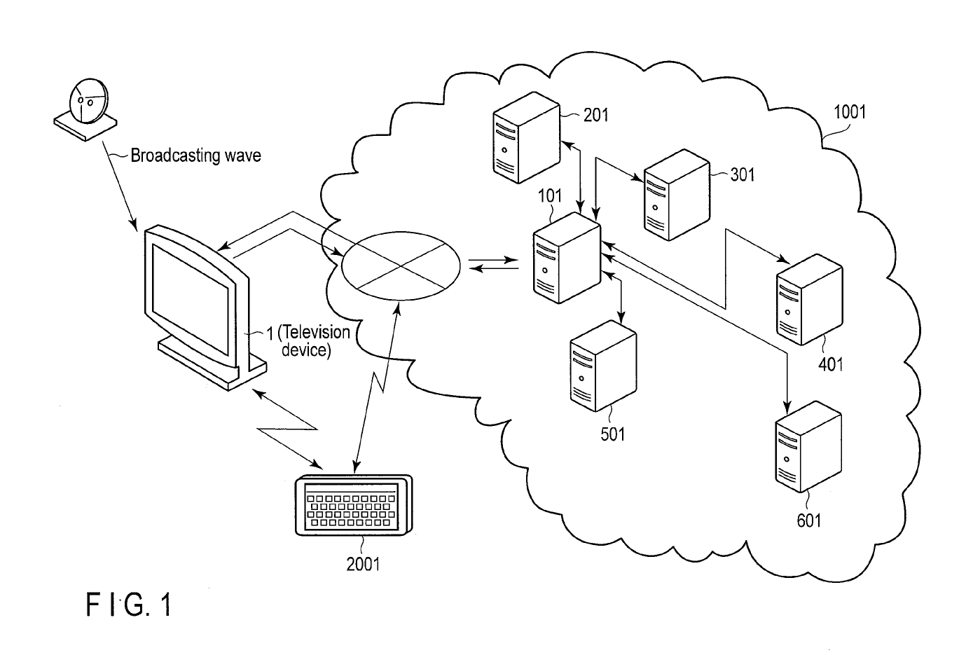

FIG. 1 shows an example of a paid content settlement system including an image reproduction device (television broadcast receiver, hereinafter referred to as a television device).

A television device 1 may be, for example, a monitor (display) configured to display an image, a speaker (acoustic reproduction device) configured to reproduce sound/audio, and a recorder configured to record an image and sound as long as the television device 1 has a processing function for processing a received broadcast that is a received program, a program-output function for outputting a program, or a storage (recording) function, etc. However, the television device 1 is clearly distinguished from personal computers (PC) as a wireless or wired external device which supports entry of character information such as a keyboard is not connected to the television device 1.

The elements or structures explained below may be realized as software by a microcomputer (a processer or a central processing unit (CPU)), or may be realized as hardware. Broadcasts may be offered by broadcasters (broadcasting stations) as broadcasting waves spreading through air, or may be distributed by distributers through networks such as cable (including light fiber) networks and the Internet Protocol (IP) network. Broadcasts include images, sound and/or music, etc., and show a form which offers a program having a unit of a certain time (broadcasting time) in succession and/or for a certain period (time). Programs are sometimes referred to as content or streams. Images include moving images, still images, text (information shown by letters or symbols indicated by coded code strings) and their arbitrary combinations.

The television device 1 is connected to a network (the Internet and/or a cloud service) 1001. The network 1001 includes a management server 101 connected to the television device 1. A portable terminal device 2001 such as a tablet PC or a smart-phone is connected to the network 1001. By this structure, the portable terminal device 2001 is allowed to exchange (receive and send) data (content) and a control signal with (from/to) the television device 1.

The network 1001 includes an external service mechanism including at least one of servers 201, . . . N01 (601 in FIG. 1; N is a positive integer). Each of servers 201, . . . , N01 is configured to exchange data (content) and a control signal with the management server 101. For example, server 201 is a server operated by a settlement company offering a settlement function executed between the server and the user that is the television device 1. Settlement (or a settlement function) refers to payment of fees every time a game, a movie, music and/or a book, etc., is downloaded (purchased), or payment of fees at the time of purchase (acquisition) of paid content which requires payment of fees for browse (play (use) for a certain period in a game). For example, server 301 is a server operated by a game company “A to Z”. Similarly, server 401 is, for example, a server operated by a movie distribution company. Server 501 is, for example, a server operated by a music content distribution company. Server 601 is, for example, a server operated by a book selling company. The management server 101 may be a server managed by the same maker as the production maker of the television device 1. When data is sent from the management server 101 managed by the same maker to another of servers 201, . . . , N01 (external service mechanism) within the network 1001, unique information indicating the management server 101 (indicating that the management server 101 is went through) can be sent.

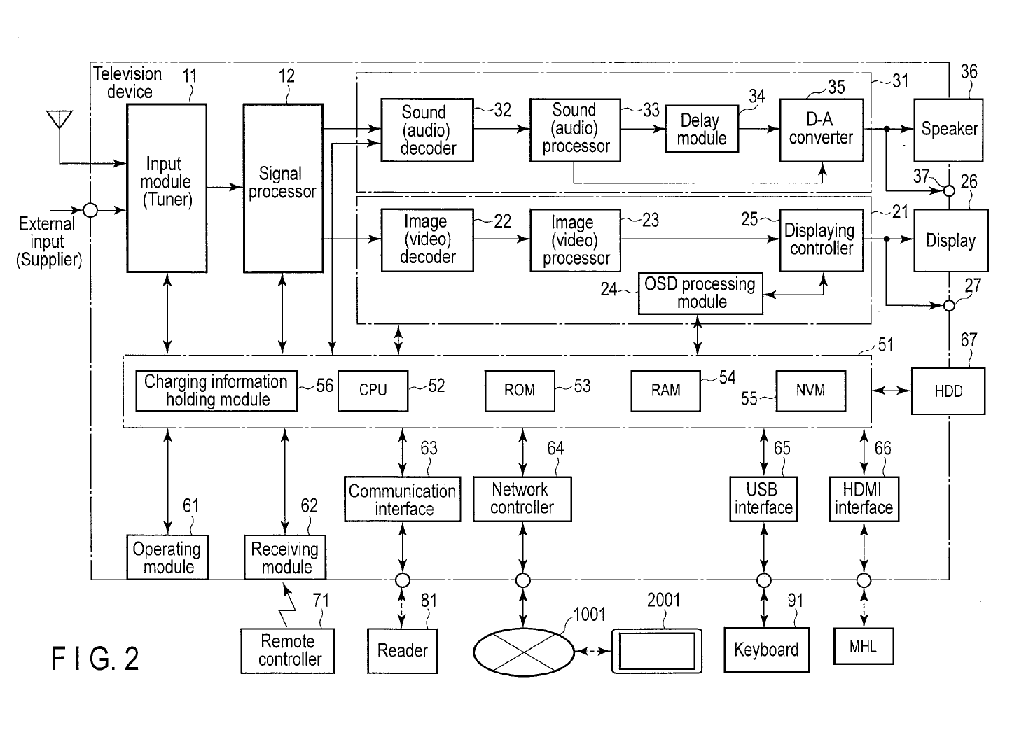

FIG. 2 shows an example of a television configured to use the paid content settlement system shown in FIG. 1.

A television device 1 includes an input module (tuner) 11, a signal processor (TS separation module) 12, an image processing block 21, a sound processing block 31 and a main control block 51, etc. An antenna configured to receive broadcasts offered as broadcasting waves is connected to the input module 11. As an external input (supplier), for example, a set top box (STB) or a recorder is also connected to the input module 11. For example, a display 26 including a liquid crystal display (LCD) panel and a speaker 36 are connected to the image processing block 21 and the sound processing block 31 respectively.

The content (broadcast) obtained by the input module 11 or external input signal (content) from the STB, etc., is separated into a transport stream (TS) which is an image signal (video) and a sound signal (audio), and control information by the signal processor 12.

An image signal (video) is decoded by an image (video) decoder 22 of the image processing block 21, and is output as a digital image signal (video output). When the external input signal (content) received in the input module 11 is, for example, an image and sound from a video camera, separation by the signal processor 12 may be unnecessary (may be omitted).

An image (video) processor 23 converts the digital image signal decoded by the image (video) decoder 22 into the predetermined resolution and output system which can be displayed in the display 26. A displaying controller 25 converts the image signal converted by the image (video) processor 23 into a display drive signal which enables a suitable display (image reproduction) in the display 26. The displaying controller 25 synthesizes an on-screen-display (OSD) image signal from an OSD processing module 24 and a display drive signal. The output of the displaying controller 25 may be output to an output connector 27 configured to be connected to, for example, an external monitor or a projector (a projection device).

A sound signal (audio) is decoded by a sound (audio) decoder 32 of the sound processing block 31.

A sound (audio) processor 33 converts the sound signal decoded by the sound (audio) decoder 32 into the predetermined form which allows a suitable reproduction in the speaker 36. A D-A converter 35 converts the sound signal converted by the sound (audio) processor 33 into an analog sound output signal. In this manner, when the speaker 36 is connected to the D-A converter 35, the speaker 36 outputs audible sound (analog sound (audio) output). For example, the output of the D-A converter 35 may branch to an output connector 37 configured to be connected to an audio-visual (AV) amplifier, etc. A delay module 34 adds the predetermined delay (time) to the sound signal which is input to the D-A converter 35 in accordance with the content type. For example, when the content is a game, the length of delay (time) defined by the delay module 34 is shorter than the length of delay (time) applied to the program which reproduces a broadcasting signal.

The main control block 51 includes, for example, a CPU (main processing circuit) 52, a read-only memory (ROM) 53 holding a control program executed by the CPU 52, a random access memory (RAM) (working memory) 54 providing the CPU 52 with a working area, a non-volatile (rewritable) memory (NVM) 55 holding various types of setting information and control information, etc., and a charging (usage) information holding module 56. An operation module 61, a receiving module 62, a communication interface 63, a network controller 64, a Universal Serial Bus (USB) interface 65, a High-definition Digital Media Interface (HDMI) (registered trademark) interface 66, and a hard disk drive (HDD) 67, etc., are connected to the main control block 51.

The operation module 61 inputs a control command corresponding to a direct operation by the user into the main control block 51.

The receiving module 62 inputs a command corresponding to an instruction (operation input) by a remote control terminal (remote controller) 71 into the main control block 51.

The communication interface 63 realizes wireless communication with a short-distance wireless communication device compatible with, for example, Wireless Fidelity (Wi-Fi) standards. As the short-distance wireless communication standards, for example, Bluetooth (registered trademark) standards and near-field communication (NFC) can be used. The communication interface 63 may employ a wired system or a wireless system. For example, a communication unit configured to exchange a signal with a wireless keyboard and mouse, etc., is connected to the communication interface 63. The communication interface 63 can also communicate with, for example, a reader (a card reader) 81 configured to communicate with a contactless card medium.

The network controller 64 controls, for example, acquisition and transmission of various types of information from an external network (the Internet [network 1001]), and access to the Internet (network 1001).

The USB Interface 65 enables use of an external device compatible with USB standards such as a keyboard.

The HDMI interface 66 enables mutual wired communication between devices using HMDI standards or MHL standards.

The HDD 67 stores the received (obtained) content. The image signal and sound signal, etc., held by the HDD 67 can be output to other devices or the network 1001 (service servers 201, . . . , N01) via the network controller 64. The image signal and sound signal, etc., which are input from other devices via the network controller 64 may be straightly reproduced in the display 26 and the speaker 36 without being held by the HDD 67.

In the CPU 52, the main control block 51 controls module elements explained below based on the operation information (control input) from the operation module 61 and the operation information (control input) received in the receiving module 62 from the remote controller 71, etc. The module elements include the display 26, the speaker 36, the signal processor 12, the image (video) decoder 22, the image (video) processor 23, the OSD processing module 24, the displaying controller 25, the sound (audio) decoder 32, the sound (audio) processor 33 and the delay module 34, etc.

The main control block 51 is configured to record an image signal and sound signal which are output by the image (video) decoder 22 and the sound (audio) decoder 32, etc., in the HDD 67 based on an operation (control input) by the user. When an image signal and sound signal, etc., are recorded in the HDD 67, the main control block 51 encrypts an image signal and sound signal, etc., and converts the signals into the predetermined record format. Based on the operation (instruction input) by the user from the remote controller 71, etc., the main control block 51 reads the desired image signal and sound signal from the HDD 67, decodes the signals, supplies them to the image (video) decoder 22 and the sound (audio) decoder 32, and executes image display and sound reproduction.

The main control block 51 is also configured to obtain caption information (including real-time captions of the speech of an anchor of the news program [announcer]) and electronic program guide (EPG) information from the TS separated by the signal processor 12 by programs or applications held by the NVM 55 or the ROM 53, or the firmware of the CPU 52.

The main control block 51 records information related to fee payment (settlement) for use of paid content, or in other words, use conditions and information required for use (hereinafter, referred to as use information), in the charging (usage) information holding module 56. The detail will be described later. The use information includes, for example, the company name of settlement, the time and date of settlement (purchase), the purchased usable time information, the remaining usable time and the name of supplier (distribution company) of paid content. The use information also includes omission of a procedure screen (display) specifying a settlement company for the purpose of simplifying the next settlement in the case of continuous use (check in the check box described later: ON), etc. As a way of paying fees (settlement) for use of paid content, for example, the user is charged (makes settlement) for every use (connection), or the user pays fees (makes settlement) based on the usable period.

When paid content is used (settlement is made), the main control block 51 controls the screen display of the television device 1 in such a way that use fees can be paid without trouble by displaying use information in the screen display of the television device 1 and obtaining approval for the use information (for example, turning ON the play button). By using the method of obtaining approval for use information (displaying a display prompting settlement [purchase] of paid content), use fees can be paid in the television device 1 (without trouble) when payment (settlement) for using paid content is needed. The use information can be displayed, for example, without excessively interrupting the progress of a game during play. Thus, extended interruption of a game due to payment (settlement) which is required during play or at the time of first purchase is avoided. Since use information goes through a management server 101, unique information indicating the management server 101 is included in information transmitted to servers 201, . . . , N01.

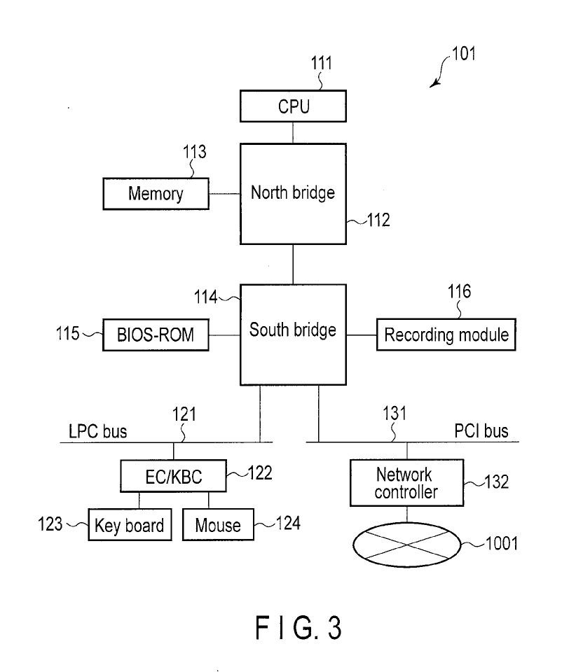

FIG. 3 shows examples of elements of a management server.

A management server 101 comprises a CPU 111, a north bridge 112, a main memory 113, a south bridge 114, a BIOS-ROM 115, a recording module 116, an embedded controller/keyboard controller IC (EC/KBC) 122 and a network controller 132, etc. The EC/KBC 122 is connected to the south bridge 114 via, for example, a Low Pin Count (LPC) bus 121. The network controller 132 is connected to the south bridge 114 via a Peripheral Component Interconnect (PCI) bus 131. A keyboard 123 and a mouse 124 are connected to the EC/KBC 122. The network controller 132 is connected to a network 1001.

The CPU 111 is a main processor configured to control the operation of the management server 101. The CPU 111 executes an operating system, various application programs and various utility programs which are loaded from the recording module 116 into the main memory 113.

The north bridge 112 connects the local bus of the CPU 111 and the south bridge 114. A memory controller configured to control the main memory 113 is embedded in the north bridge 112.

For example, the south bridge 114 functions as an I/O controller for controlling various I/O devices connected to the PCI bus 131 and the LPC bus. The south bridge 114 includes an Integrated Drive Electronics (IDE) controller configured to control the recording module 116. The access of the BIOS-ROM 115 is also controlled by the south bridge 114. The BIOS-ROM 115 is, for example, a flash ROM in which a system BIOS is electrically rewritably stored.

The EC/KBC 122 is a single-chip microcomputer which integrates an embedded controller for power source management and a keyboard controller configured to control the keyboard (KB) 123 and the mouse 124, etc. A network controller 119 controls data communication (exchange of data and reception and transmission of a control signal) with other users via the network (Internet) 1001.

The recording module 116 retains control information between the user (television device 1) and an arbitrary one of servers 201, . . . , N01 which is connected to the user (television device 1) via the network 1001, and rules applied by the management server 101 to information from the user (television device 1), etc. The recording module 116 also retains a password which allows the user to access an arbitrary one of servers 201, . . . , N01.

The rules applied by the management server 101 to the information from the user (television device 1) include, for example, a routine of payment (settlement) in the case where paid content is used. The routine of payment (settlement) includes, for example, at least one of the following a) to d):
a) for example, when the user (television device 1) uses a paid game of a game company which operates server 301, the user makes settlement via server 201 operated by a settlement company;
b) server 301 of the game company receives use fees (fees information) only from settlement company 201 (direct settlement is not made between the user and the game company);
c) server 301 of the game company is configured to supply a game (content) to the user (television device 1) only through the management server 101; and
d) regarding a game which has been used through a “free” button allowing free use for a certain period, selection input for the second time or after is not accepted (the management server 101 manages the number of times of selecting the “free” button relative to server 301 of the game company).

Thus, the management server 101 is allowed to provide (server 201 of) the settlement company with settlement information of the television device 1 based on special rules between the television device 1 (user) and another server in the network 1001.

As described in the above d), regarding a game whose settlement has been requested from the user (television device 1), the management server 101 is configured to undertake a part of management of request (information) for the game company operating server 301 from the user (television device 1).

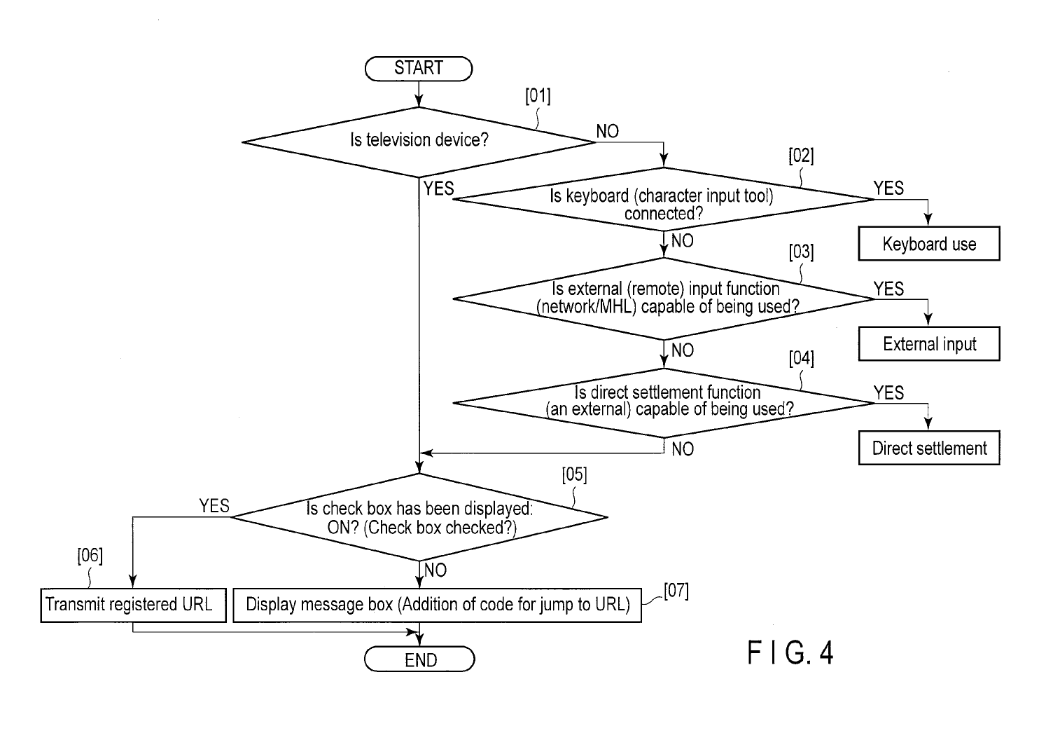

FIG. 4 shows examples of operations of the paid content settlement systems shown in FIG. 1 to FIG. 3, and examples of operations of a television for exchanging data (making settlement) between the television and a management server in the systems as software.

When a user (television device 1) accesses a game supplier (server 301 in FIG. 1) in order to use paid content via a network 1001, a purchase screen of a settlement company (server 201 in FIG. 1) cooperating with the game supplier is displayed via the network 1001. In the case where a user (television device 1) purchases a paid game from a game supplier (server 301), user registration (account acquisition) and password setting are necessary in advance by means of a portable terminal device (tablet terminal) or a personal computer (PC), etc. Settlement (purchase of paid content by the television device 1) between the settlement company (server 201) and the user (television device 1) is conducted in the PC or tablet terminal in which an account has been obtained. In contrast, at the time of purchase of a game (paid content), it is possible to access the game supplier (server 301) from the screen display of the television device 1. This will be explained later with reference to FIG. 6 to FIG. 8. Therefore, when the right to use a game for the predetermined days is purchased from the television device 1, it is necessary to notify the PC or tablet terminal holding the account of the game purchase at least once (in the first purchase). However, in many cases, it takes time to input a uniform resource locator (URL) used for access to the PC or tablet terminal holding the account by means of a software keyboard provided in the television device 1.

For the above reason, in FIG. 4, when a keyboard, etc., which is an external device for inputting characters is not used, whether or not the television device 1 which takes time in many cases to input a URL used for access to the PC or tablet terminal for settlement is used is checked [01].

If the detected device is not a television [01—NO], availability of an input tool suitable for character input is checked. For example, the availability is checked with respect to the following points in accordance with the predetermined order: whether or not a keyboard is connected as an input tool [02], whether or not an external (remote) input function (network/MHL) is available [03], and whether or not a (external) direct settlement function is available [04].

If the detected device is a television[01—YES], whether or not a check box is checked (check box: ON) is checked [05]. A checked check box indicates that a similar settlement has been made or the user recognizes that the URL used for access to the PC or tablet terminal for settlement has been already registered.

If the check box is checked [05—YES], in line with the display of the message box, the URL which is registered in advance and is used for access for settlement is transmitted to, for example, a tablet terminal 2001 held by the user [06].

If the check box is not checked [05—NO], a message box displaying a message for transmitting the URL for settlement to, for example, the tablet terminal 2001 held by the user is displayed as an OSD on the screen displayed in the television device 1. In addition to the message displayed by the message box, for example, a code which allows acquisition of the URL used for access for settlement by optical recognition can be displayed [07]. The URL used for access for settlement is input in the television device 1 in advance from the device holding the account, or in short, from the tablet terminal 2001 (or PC), and is held in, for example, a charging (usage) information holding module 56.

In contrast, even if an input tool for inputting a URL is available [01—NO], a keyboard may not be connected [02—NO], or an external (remote) input function (network/MHL) may not be available [03—NO], or a (external) settlement function may not be accessed [04—NO]. In these cases, whether or not the check box is checked is determined [05], and the URL may be sent as described above.

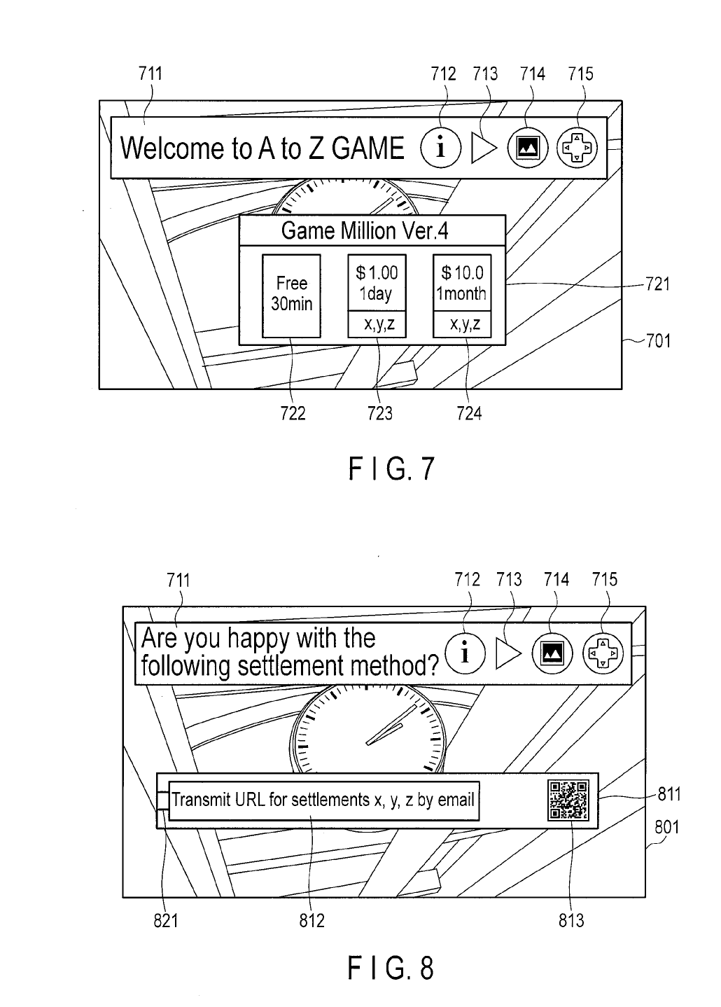

If a keyboard is connected [02—YES] or an external (remote) input function (network/MHL) is used [03—YES], a different screen display may be displayed. Similarly, if a (external) direct settlement function is used [04—YES], a different screen display may be displayed. The screen display includes, for example, a confirmation screen which allows input of an instruction for cancelation (cancelation of purchase of a game) or an instruction for change in the method for accessing a settlement screen, etc., and an input screen which allows return to watching of a television broadcast. When the playable time of a game is finished, the purchase screen explained by using FIG. 7 may be displayed, and a screen display which prompts purchase of continuous play of the game may be displayed.

A main control block 51 transmits the above-described screen displays shown in FIG. 7 and FIG. 8 and a URL used for access for settlement to the tablet terminal 2001 (or PC) holding the account by email. The transmission of the URL which is registered in advance and is used for access for settlement to the tablet terminal (PC) at the time of settlement (purchase) by email is useful for enhancing the immediacy of settlement in the television device 1 which does not have an external input support tool used for inputting character information, etc.

Thus, user-friendliness is largely improved by the structure in which use information can be input without an input support tool which is connected to the television device 1 or which is recognized at the time of completion of boot of the television device 1.

For example, when a contactless charging information holding medium such as a (wireless/contactless) prepaid card is located in the information detection area of a card reader 81 connected to a communication interface 63, the main control block 51 controls the medium as an available settlement method. For example, when a character information input support tool such as a USB keyboard 91 is connected to a USB interface 65 and settlement information is directly input, the main control block 51 controls the information as an available settlement method. Further, for example, the main control block 51 is configured to display a coded code including URL link information in the screen display in such a way that a code including the URL link information can be read by the reader function of a portable terminal device. In short, the main control block 51 enables reading of a code by means of a portable terminal device and access to a URL (of a settlement company) from a portable terminal device as settlement methods. The main control block 51 also controls a settlement method of only verification with a settlement account by email with regard to a settlement account which is processed (settled) in advance in an external device as an available settlement method. However, by using the method of obtaining approval for use information displayed in the screen display (turning on a play button), use fees can be easily settled even during use (play) of a paid game.

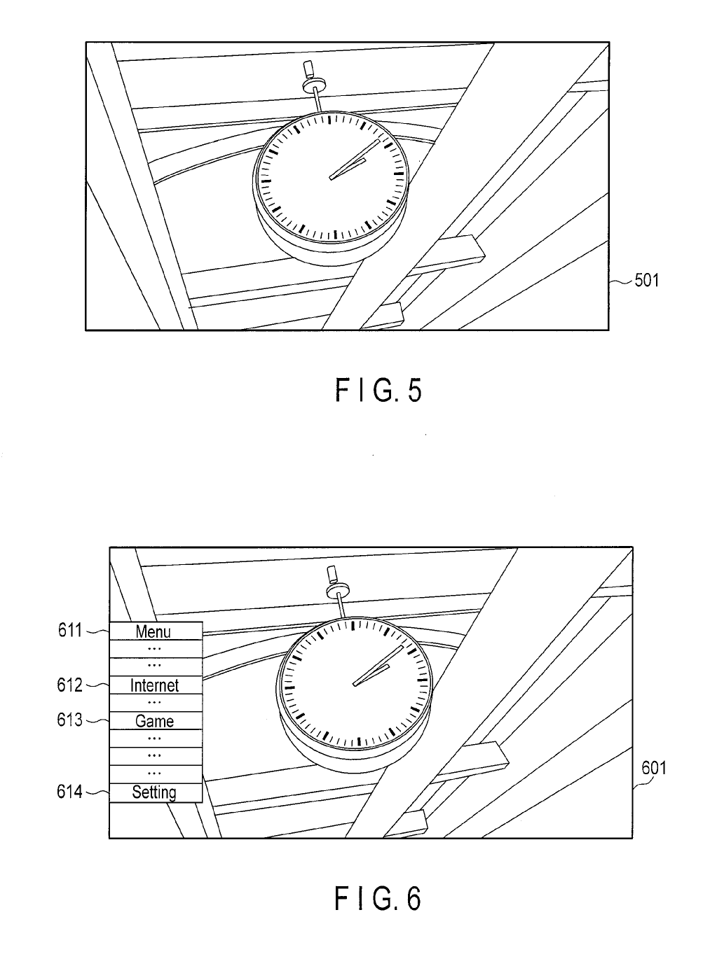

FIG. 5 to FIG. 8 show screen display examples for realizing input of a URL for settlement by means of a dedicated character input tool in the user (television device 1) shown in FIG. 4.

For example, while a broadcast (content) such as a movie is viewed, an instruction for display of a menu screen is input in a state in which a screen display 501 is displayed (FIG. 5). Then, as shown in FIG. 6, a screen display 601 including a menu display 611 at the predetermined position of the display screen is displayed. The instruction for the menu screen is input by, for example, the operation of a remote controller by the user.

The menu display 611 (FIG. 6) includes, for example, an Internet display (bar) 612 which allows connection to the Internet, a game display (bar) 613 which allows access to (server 301 of) a game supplier, etc., and a setting display (bar) 614 which allows instruction input of various types of settings for a television device 1. The game display (bar) 613 which allows use of games (paid content) is displayed when user registration (account acquisition) and password setting are completed by means of a portable tablet device (tablet terminal) or a personal computer (PC) as described above. When account acquisition (user registration) or password setting is not completed, the game display (bar) 613 is not displayed, or displayed in gray.

In the case where a paid game supplied by a game supplier is used, if an instruction for determination is input (an OK button is pressed) with focus on the game display (bar) 613, a portal screen of the game supplier is displayed. An example of this screen is shown in FIG. 7. The portal screen (FIG. 7) displays a screen display 701 including, at the predetermined positions of the display screen, a supplier name display 711, a use explanation icon 712, a use start icon 713, a display switching icon 714 which allows input of instruction for switching the screen display, and a function display icon 715 which explains operations of the cursor and the actions corresponding to the operations, etc.

The screen display (portal screen) 701 also includes (displays) a game selection box display 721 which displays, for example, a (recommended) game name and use fees at the predetermined position in the display area.

The game selection box display 721 displays a list of usable times and fees in, for example, a button form. In many games, fee plans of a “free” button display 722, a “first purchase plan” button display 723 and a “second purchase plan” button display 724, etc., are included although the display differs depending on the type, release time and popularity of the game, etc. The “free” button display 722 indicates that free use for a certain period is available. The “first purchase plan” button display 723 and the “second purchase plan” button display 724 display the first usable time and its price (fees/purchased amount), and the second usable time and its price (fees/purchased amount) respectively. The second usable time or its price is different from the first usable time or its price. Each of the “first purchase plan” button display 723 and the “second purchase plan” button display 724 integrally includes a settlement company display showing settlement company names (x, y, z) which are different from the game supplier (A to Z GAME).

For example, when an instruction for determination is input (an OK button is pressed) with focus on the “first purchase plan” button display 723, the display of the supplier name display 711 is changed to a “message” display for confirming the settlement method, and a message box 811 is displayed at the predetermined position on the display screen (shown in FIG. 8).

The message box 811 displays, for example, a message 812 showing “transmit URL used for access to settlements x, y, z by email”. The message box 811 includes a check box (display) 821 (corresponding to [01—YES] and [05] in FIG. 4). When the check box 821 is checked, this checked box indicates that a similar settlement has been executed or the user recognizes that the URL used for access to the tablet terminal or PC for settlement has been already registered. The message box 811 may also display a code 813 which allows acquisition of the URL by optical recognition. The URL transmitted by email or the URL which is obtainable by the code 813 and is used for access to a tablet terminal 2001 or PC may include information specifying that the management server 101 is went through (a management server 101 is accessed).

FIG. 10 shows an example of a display of a settlement screen of a settlement company (server 201 in FIG. 1) which is associated with the account held by a tablet terminal 2001 or PC by selecting “transmit URL used for access for settlements x, y, z by email”. At the time of connection between server 201 and the user (television device 1), the rules (for example, a to d) held by a recording module 116 of a management server 101 are followed after connection to a network 1001 through the tablet terminal 2001 or PC. The rules (a to d) are defined in advance between the user (television device 1) and server 201 (settlement company), and are also maintained at the time of connection to the network 1001 through the tablet terminal 2001 or PC.

The settlement screen shown in FIG. 10 includes a message box 1031 including a company name displaying area 1021, a password entry field 1032, a user name displaying field 1033, a phone field 1034, a credit company specifying field 1035 and an entry box field 1036, etc., a “cancel” button display 1041 and a “done” button 1051, etc. The company name display area 1021 specifies the settlement company name. The password entry field 1032 is used for inputting a password for the account (user registration). The user name displaying field 1033 displays the input user name. The phone field 1034 displays the input contact address such as a telephone number or email address which can specify the user, etc. In the credit company specifying field 1035, a plurality of credit card companies can be selected by, for example, a check box system. In the entry box field 1036, a card number given by the selected credit card company is input. An instruction for cancelation (of settlement) can be input by using the “cancel” button display 1041. An instruction for “OK” (input completion or approval for settlement) can be input by using the “done” button 1051.

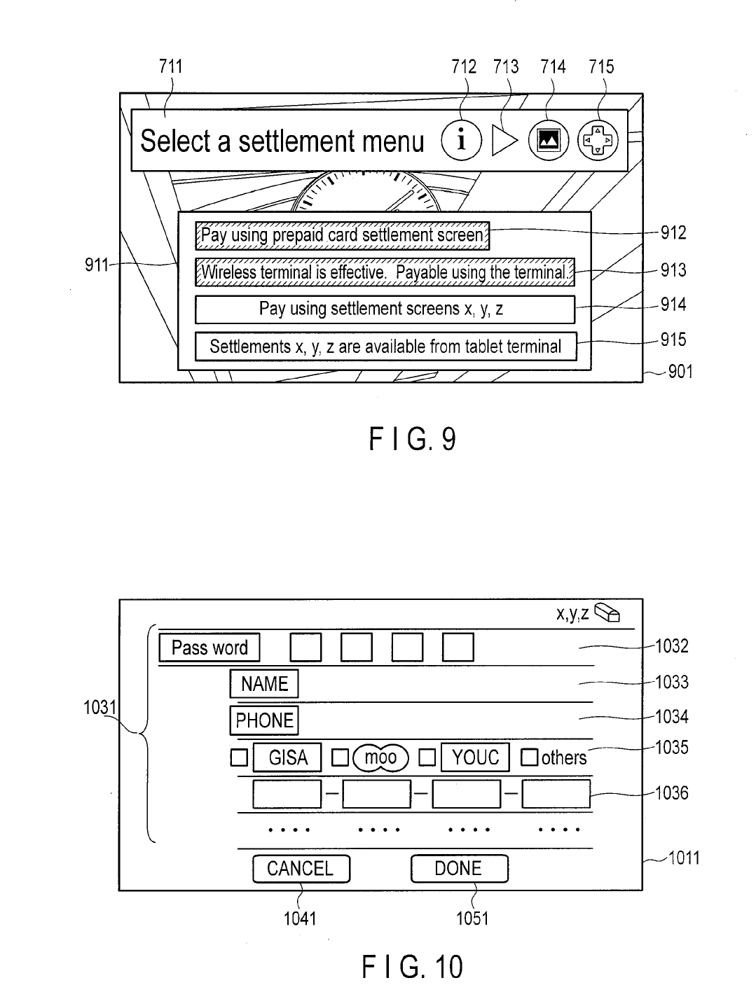

FIG. 9 is an example of a screen display corresponding to, for example, [01—NO] and [04—YES] in FIG. 4. For example, FIG. 9 is an example of a screen display which prompts “jump to settlement screens x, y, z” by means of a tablet terminal 2001 in a state in which connection with a reader 81 or a keyboard 91 cannot be recognized. A message box 911 includes message displays 912 and 914 displaying available settlement methods, and messages 913 and 915 prompting settlement (purchase) using the settlement methods which are displayed by the message displays respectively. Message display 912 displays, for example, a message indicating that prepaid card settlement using the reader 81 is available. Message display 914 indicates that settlement using the tablet terminal device 2001 is available. For example, in a state in which connection with the reader 81 cannot be recognized (settlement cannot be made), message display 912 and message 913 which shows that settlement using the reader 81 is available are displayed in gray. Message 915 prompts the user to “jump to settlement screens x, y, z” by means of the tablet terminal device 2001. In a screen display 901, the display of a supplier name display 711 is changed to a message display which prompts selection of a settlement method, i.e., “Select a settlement menu”.

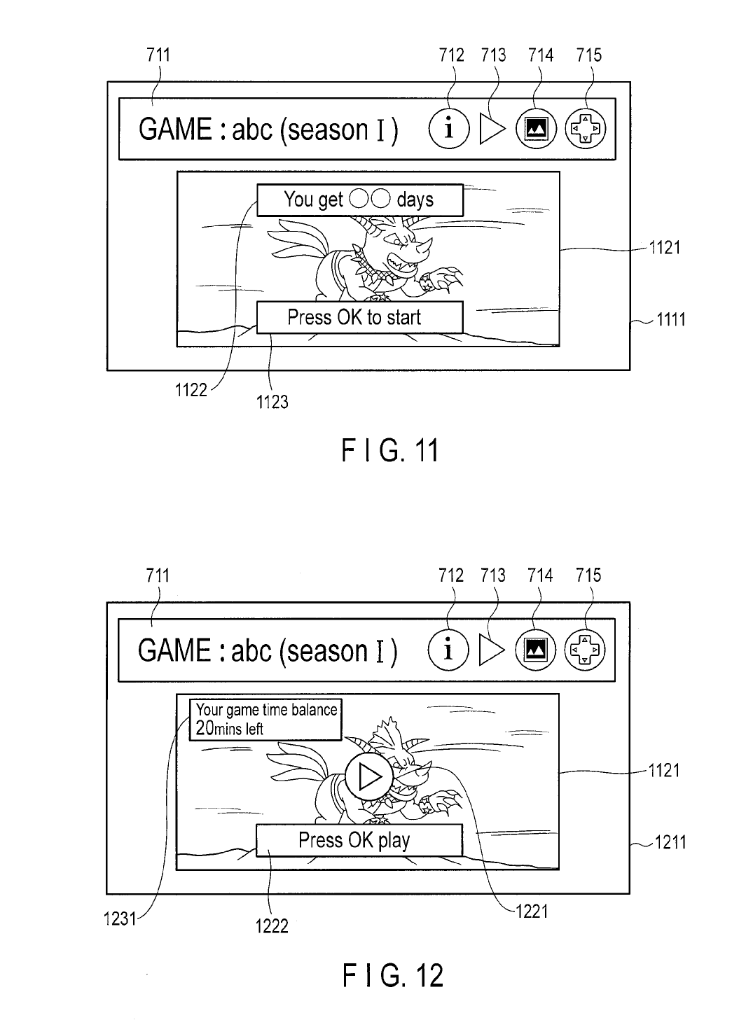

FIG. 11 shows an example of a display in a state in which a purchased game is allowed to be started after completion of settlement of a settlement company.

In a screen display 1111, the display of a supplier name display 711 is changed to, for example, the display of the name of the purchased game (for which settlement has been made), and a game screen display 1121 displaying the game is displayed. In the game screen display 1121, message display 1122 and message display 1123 are displayed. Message display 1122 displays, for example, a message for appreciation of purchase (use). Message display 1123 displays a message which prompts start of the game through an ON (OK) operation by a play button 713. The size of the game screen display 1121 may be the predetermined size within the screen display 1111 (the display size may be limited) based on the specification of the game supplier.

FIG. 12 shows an example of a screen display when the usable time of a (purchased) game whose settlement has been completed through a settlement company is close to expiration of the purchased plan.

A screen display 1211 shown in FIG. 12 displays a remaining time display 1231 showing the remaining time of the purchased usable time, and a play button display 1221 showing that the game can be continued. In addition to the play button display 1221, a message display 1222 may be displayed. The message display 1222 displays a message showing that the game can be continued during the remaining time through ON (OK) of the play button display 1221.

For example, when the game usable time is finished, the purchase screen explained with reference to FIG. 7 may be displayed, or a screen display which prompts purchase of continuous play of the game may be displayed.

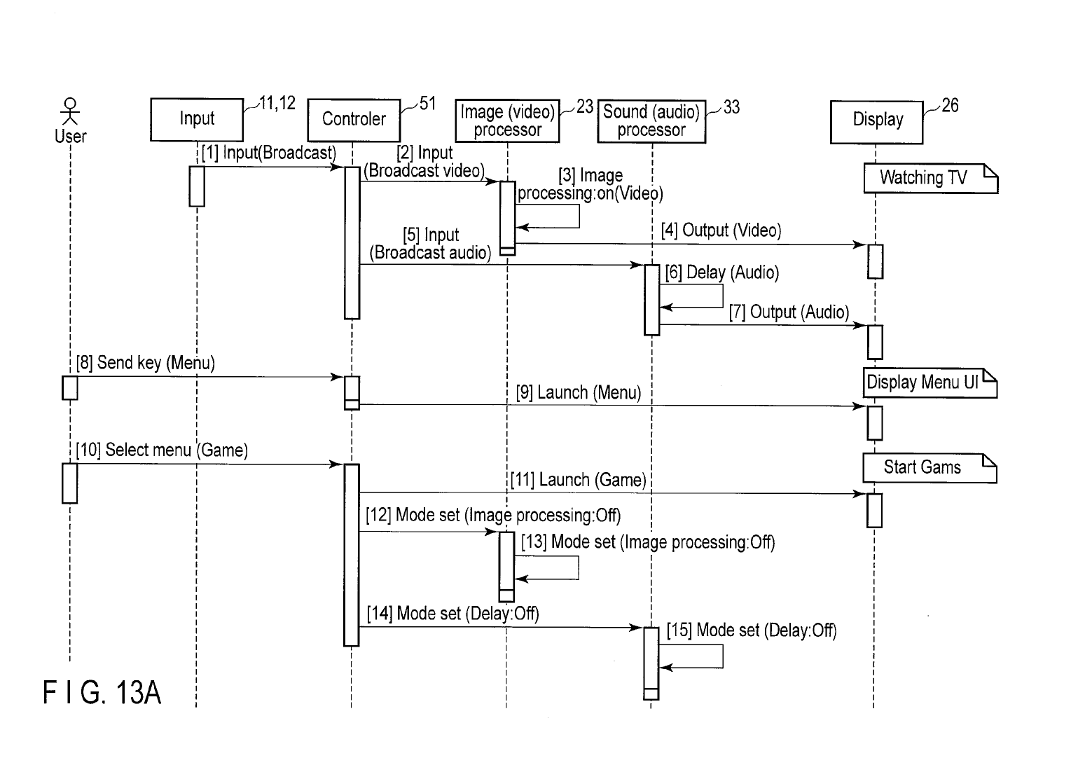

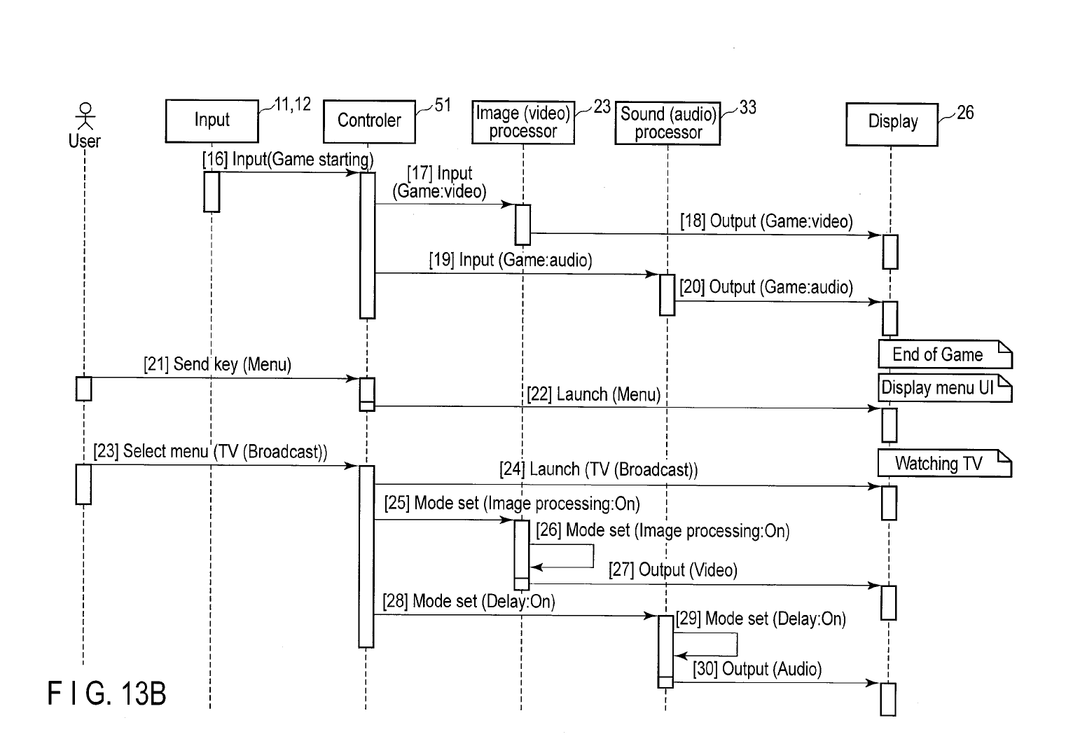

FIG. 13A and FIG. 13B show an example of a method for changing the screen display and audio output of a display 26 to a display/output mode suitable for games after permission of use of a game (completion of purchase), or a method for setting the screen display so as to be a display mode/audio output suitable for an image (content) which is displayed next in the case where the game is finished in accordance with FIG. 7, FIG. 8 and FIG. 10.

In the case where the user boots a television, in the television device 1, an input (an input module 11 or a signal processor 12) notifies a controller 51 that the input is a broadcast [1].

The controller 51 notifies an image (video) processor 23 that the input is a broadcast [2].

The image (video) processor 23 sets the image processing so as to be suitable for video [3], and outputs video to the display 26 [4].

The controller 51 notifies a sound (audio) processor 33 that the input is a broadcast [5].

The sound (audio) processor 33 sets the predetermined length (time) of delay for a delay module 34, and outputs audio to which the predetermined delay is added to a speaker 36 [7].

When the user inputs an instruction for displaying a menu screen in consideration of use of a game [8], the controller 51 causes the display 26 to display the menu screen[9].

When the user inputs an instruction for the game from the menu screen[10], the controller 51 notifies the display 26 of (use of) the game [11].

The controller 51 notifies the image (video) processor 23 that the image processing directed to video should be cancelled (OFF) [12]. The image (video) processor 23 sets the video output so as to be in a state in which the image processing directed to video is cancelled [13].

The controller 51 notifies the sound (audio) processor 33 that the delay should be cancelled [14]. The sound (audio) processor 33 sets a delay-off mode [15].

Hereinafter, the controller 51 notifies the image (video) processor 23 that the input is a game [16].

The image (video) processor 23 is changed so as to accept the input (game) in a state in which the image processing directed to video is cancelled [17]. The image (video) processor 23 outputs video (game) to the display 26 [18]. In the video (image) of games, etc., the degree of image processing added to video of television broadcasts (movies), etc., is small. Therefore, the “delay” processing required in reproduction of sound associated with video of television broadcasts, etc., is unnecessary (there is no time-lag until the reproduced video is output).

The sound (audio) processor 33 receives input (audio) in the delay-off mode[19], and outputs audio (game) to the speaker 36 [20]. Thus, it is possible to prevent a temporal “gap” between audio reproduction and screen display when a game is used (speeding up of audio/sound output (prevention of time-lag)).

When the user inputs an instruction for displaying the menu screen in the end of the game [21], the controller 51 notifies the display 26 that the menu screen should be displayed [22].

When the user inputs an instruction for viewing a television broadcast (content) from the menu screen[23], the controller 51 notifies to the image (video) processor 23 and the sound (audio) processor 33, into the display 26 is a broadcast is input [24].

Hereinafter, the controller 51 notifies the image (video) processor 23 that the image processing suitable for video should be executed (ON) [25]. The image (video) processor 23 sets the video output in such a way that the image processing suitable for video can be applied to the video output [26]. The image (video) processor 23 outputs video to the display 26 [27].

The controller 51 notifies the sound (audio) processor 33 that delay should be applied [28]. The sound (audio) processor 33 sets delay [29], and outputs audio to which the predetermined delay is added to the speaker 36 [30].

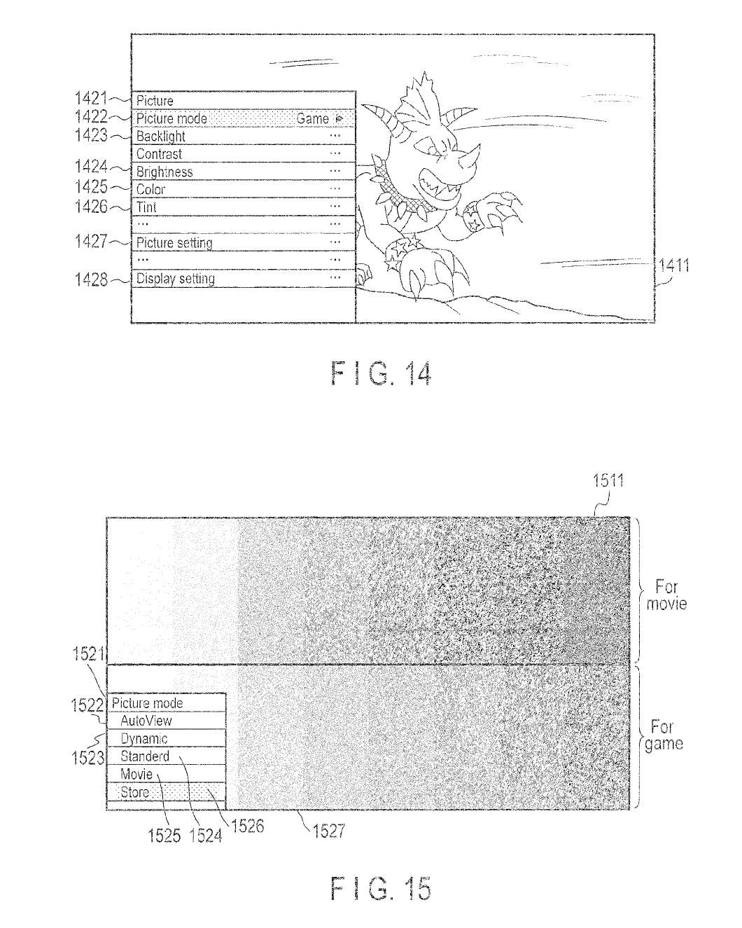

FIG. 14 and FIG. 15 show an example of a method for enabling the user to confirm the display characteristics of the display when the screen display of the display is switched to a display mode suitable for games by means of the methods shown in FIG. 13A and FIG. 13B.

For example, when an instruction for displaying display characteristics (picture) is input, a picture display 1421 is displayed at the predetermined position of a screen display 1411 displayed by a display 26. An example of this display is shown in FIG. 14.

The picture (display) 1421 includes, for example, a picture mode display 1422, a backlight display 1423, a brightness display 1424, a color display 1425, a tint display 1426 and picture setting display 1427 and a display setting display 1428, etc. In the display example, the picture mode display 1422 is set as “game”, and the characteristics of a display mode suitable for games can be displayed.

For example, when an instruction for OK is input with a focus on the picture mode display 1422, selectable display characteristics (picture) includes, for example, an auto view display 1522, a dynamic display 1523, a standard display 1524, a movie display 1525 and a game display 1526, etc., as shown in FIG. 15. In the display example, the display pattern (color bar) (for example, for movies) before change is displayed in the upper stage, and the display pattern (color bar) (for games) after change is displayed in the lower stage. This enables the user to confirm the characteristics of a display mode suitable for games.

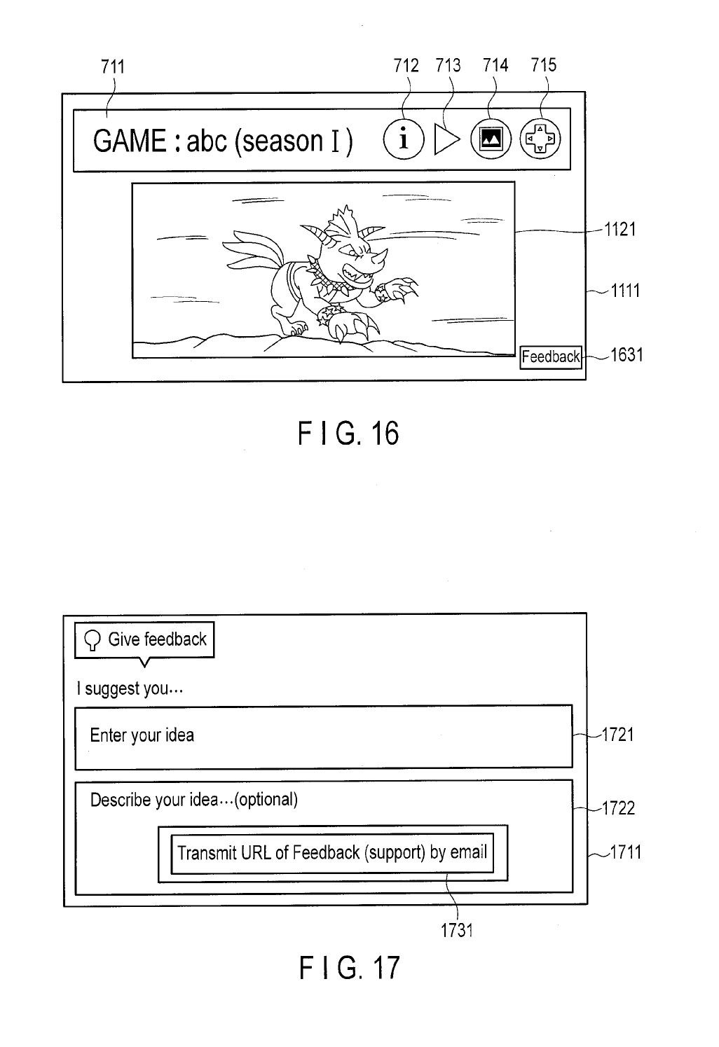

FIG. 16 shows an example of a display during use (play) of a purchased game.

In a screen display 1111, a game screen display 1121 and a feedback button display 1631 are displayed.

The feedback button display 1631 is used for reception of messages from users to the game supplier managing server 301 (contact to the service center).

When the feedback button display 1631 is on (OK is input), an input form is sent by email to, for example, a tablet device or portable terminal device 2001 which is the user (account) registered in advance. An example of the input form is shown in FIG. 17.

The feedback input form 1711 shown in FIG. 17 includes, for example, a first entry field 1721, which allows input of information to be sent from the user to the game supplier in categories (ideas (feedback), claims, support and call-up) desired by the user, and a second entry field 1722, which allows input of detailed message.

The feedback input form 1711 also includes a transmission button display 1731 configured to specify that a management server 101 is passed through (the management server 101 is accessed) as the URL used for transmitting a feedback message. In the transmission button display 1731, a code which enables acquisition of the URL by means of optical recognition may be displayed together.

Feedback can be delivered via the management server 101 to server 301 managed by the game supplier by inputting the predetermined information in the input form 1711 and transmitting it through the transmission button display 1731.

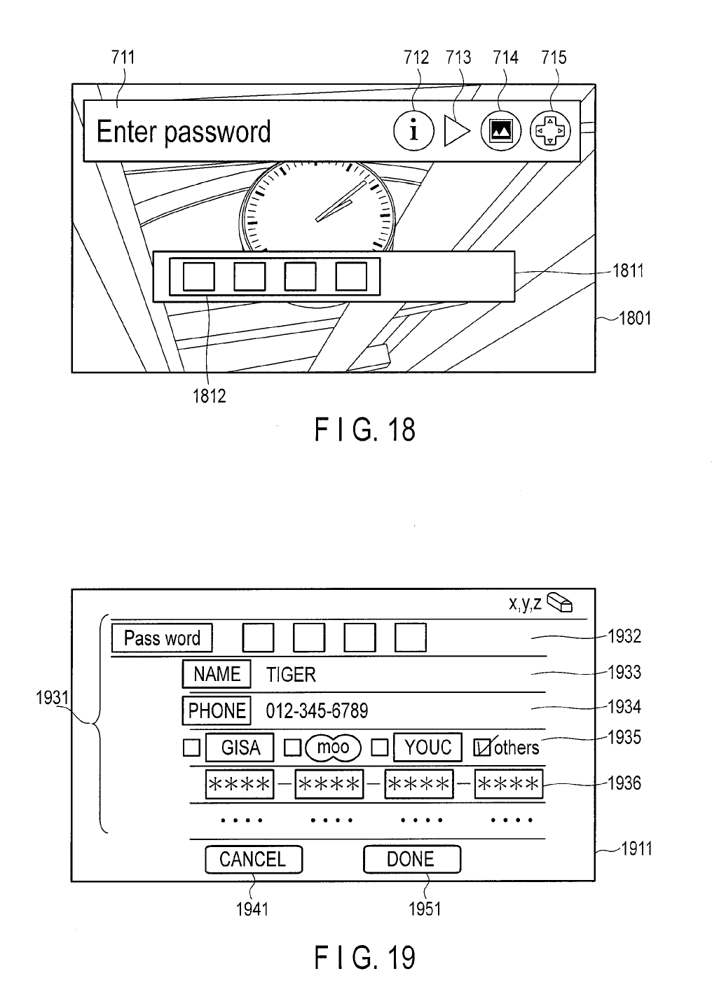

FIG. 18 is an example of a screen display which is useful in the case where a game is purchased when, for example, the game usable time is finished, or the remaining (game) usable time reaches the predetermined time.

If an account is already registered (user registration is already finished), and the account held by a tablet terminal 2001 or PC for settlement can be specified, it is possible to purchase continuous use of the game by only inputting a password. In this case, when an arbitrary plan is selected from the purchase screen shown in FIG. 7, the password input screen shown in FIG. 18 is displayed. For example, a message display field 711 prompts input of a password, and a password entry field 1811 and an entry box 1812 are displayed. In many cases, a password consists of the predetermined digits (the predetermined number of figures). Thus, even if input by a remote controller 71 is needed, the password can be comparatively easily input. In this manner, the time required for settlement (purchase) can be reduced, and the time in which the game is stopped can be minimized.

FIG. 19 is an example of a useful settlement screen display in a settlement company in the case where a game is purchased when, for example, the game usable time is finished, or the remaining (game) usable time reaches the predetermined time.

When the password which is input on the password input screen on the television device 1 side in FIG. 18 agrees with the password which is set in the user registration (account acquisition), settlement may be made merely by inputting the password in the settlement screen in the settlement company (server 201). If an account is already registered, and the account held by a tablet terminal 2001 or PC can be specified, information (which is already input) is displayed. Confirmation of the information and password input are requested. If the passwords agree, settlement (purchase) is finished. In a screen display 1911, a company name display area 1921, a cancel button display 1941 and a done button 1951 are the same as the (initial) input screen shown in FIG. 10. A message box 1931 displays information which is already input regarding a user name display field 1933, a phone field 1934, a credit company specifying field 1935 and an entry box field 1936. Thus, if the password which is input in a password entry field 1932 agrees with the registered password, settlement is completed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments can be also realized in the following structures.

In the case where a broadcast receiver having a network function is provided with a game function by a cloud gaming, the broadcast receiver is provided with a function for automatically changing display and audio output so as to prioritize performance without having the user set the function at the time of execution of the game. Thus, users receive the benefit of convenience.

Device information of a client is reported to a server application. This allows provision of a settlement function which is suitable for the device and/or environment. The server application provides a structure which can be applied in common with a terminal.

In the case where the device is a broadcast receiver, the broadcast receiver is only provided with verification by a settlement account by email, or transmission of homepage address for the Internet settlement to another information processor by email. In the case of an information processor, the information processor is provided with both the function of credit information input settlement and the function of settlement account.

In the case where a keyboard is connected to a broadcast receiver, the broadcast receiver is provided with both the function of credit information input settlement and the function of settlement account.

In the case where a broadcast receiver can be remotely handled from a terminal device such as a tablet, the broadcast receiver is provided with both the function of credit information input settlement and the function of settlement account.

In the case where a contactless terminal device is connected to a broadcast receiver, the broadcast receiver further has a contactless settlement function.

What is claimed is:

1. A broadcast receiver comprising:
a display configured to display an image of reproduced content; and
a controller configured to transmit settlement information related to settlement fees to a communication device storing contract information of paid content or a specific management device, when a support device for character input is not connected and the content displayed by the display is paid content.

2. The broadcast receiver of claim 1, further comprising:
a settlement information storage module configured to store the settlement information.

3. The broadcast receiver of claim 2, wherein the settlement information includes specific information defining transmission from the specific management device to a settlement partner via the communication device storing the contract information of the paid content or the specific management device.

4. The broadcast receiver of claim 3, further comprising:
a display controller configured to display the specific information prompting for transmitting the settlement information, overlapping with the image of the reproduced content displayed by the display, to the communication device storing the contract information of the paid content or the specific management device,
wherein the settlement information is stored by the settlement information storage module.

5. The broadcast receiver of claim 4, wherein the display controller is configured to display the specific information overlapping with the image of the reproduced content displayed by the display so that the controller is allowed to receive an input instruction for the specific information.

6. A fees settlement system comprising:
a broadcast receiver configured to reproduce content; and
a specific management device configured to receive settlement information related to payment of fees from the broadcast receiver and transmit specific information indicating that a transmitting source device is the specific management device, when the content reproduced by the broadcast receiver is paid content.

7. The fees settlement system of claim 6, wherein the broadcast receiver further comprises a settlement information storing module configured to store the specific information.

8. The fees settlement system of claim 7, wherein the settlement information includes the specific information in which the specific management device is allowed to add.

9. The fees settlement system of claim 7, wherein the settlement information includes settlement partner information.

10. A broadcast receiver comprising:
a display configured to display an image of content;
an acoustic reproduction module configured to reproduce audio of the content;
an input detector configured to detect that the content is a game; and
an acoustic processor configured to cancel a delay component added to the audio when the input detector detects that the content is a game.
